(19) United States
(12) Patent Application Publication
(10) Pub. No.: US 2024/0406726 A1
(43) Pub. Date: Dec. 5, 2024

(54) WIRELESS ACCESS METHOD

(71) Applicant: Realtek Semiconductor Corporation, Hsinchu (TW)

(72) Inventors: Quan YANG, Jiangsu Province (CN); Junjie QIN, Jiangsu Province (CN); Ting GAO, Jiangsu Province (CN)

(21) Appl. No.: 18/673,340

(22) Filed: May 24, 2024

(30) Foreign Application Priority Data
May 30, 2023 (CN) 202310622154.3

(51) Int. Cl. H04W 12/069; H04W 12/041; H04W 12/106

(52) U.S. Cl. CPC H04W 12/069; H04W 12/041; H04W 12/106

(57) ABSTRACT

A wireless access method includes the following steps. An access point obtains a personal identification number of a terminal device and broadcasts a beacon. The access point performs a terminal device authentication on a vendor specific information element of a probe request from the terminal device according to the personal identification number. When the terminal device authentication is successful, the access point performs a key calculation according to the personal identification number and the probe request to generate a pairwise transient key, a key encryption key and a group transient key and uses the key encryption key to encrypt a pre-shared key and the group transient key. The access point transmits a probe response to the terminal device. The access point installs the pairwise transient key and the group transient key to establish an encrypted transmission.

### CROSS-REFERENCE TO RELATED APPLICATION

This application claims priority to China Application Serial Number 202310622154.3, filed May 30, 2023, which is herein incorporated by reference in its entirety.

### BACKGROUND

### Field of Invention

The present disclosure relates to a communication technology. More particularly, the present disclosure relates to a wireless access method.

### Description of Related Art

Current wireless access technology requires complicate mechanisms to establish an encrypted connection between a terminal device and an access point. For example, the encrypted connection cannot be established before an association stage and a key negotiation stage are completed in Wi-Fi connection technology currently. The steps of the establishment of the encrypted connection are complex and time-consuming. Although it is possible to speed up the establishment of the encrypted connection by adding software or hardware functions, a lot of resources are needed. In addition, when an internet of things (IoT) device intends to establish the encrypted connection with the access point, it is often impossible to select a service set identifier of the access point and enter a password due to lack of a visual input user interface.

### SUMMARY

The disclosure provides a wireless access method comprising the following steps: (a) an access point obtains a personal identification number of a terminal device and broadcasts a beacon comprising a first vendor specific information element; (b) the access point receives a probe request from the terminal device comprising a second vendor specific information element and performs a terminal device authentication on the second vendor specific information element according to the personal identification number; (c) when the terminal device authentication is successful, the access point performs a key calculation according to the personal identification number and the probe request to generate a pairwise transient key, a key encryption key, and a group transient key and encrypts a pre-shared key and the group transient key of the access point by using the key encryption key to generate an encrypted pre-shared key and an encrypted group transient key; (d) the access point transmits a probe response comprising a third vendor specific information element to the terminal device, wherein the third vendor specific information element comprises the encrypted pre-shared key and the encrypted group transient key; and (e) the access point installs the pairwise transient key and the group transient key to establish an encrypted transmission.

The disclosure also provides a wireless access method comprising the following steps: (a) a terminal device receives a beacon from an access point comprising a first vendor specific information element and performs a first access point authentication on the first vendor specific information element according to a personal identification number of the terminal device; (b) when the first access point authentication is successful, the terminal device broadcasts a probe request comprising a second vendor specific information element; (c) the terminal device receives a probe response comprising a third vendor specific information element from the access point and performs a second access point authentication on the third vendor specific information element according to the personal identification number, wherein the third vendor specific information element comprises an encrypted pre-shared key and an encrypted group transient key; (d) when the second access point authentication is successful, the terminal device performs a key calculation according to the personal identification number and the probe response to generate a pairwise transient key and a key encryption key and decrypts the encrypted pre-shared key and the encrypted group transient key by using the key encryption key; and (e) the terminal device stores a pre-shared key and installs the pairwise transient key and the group transient key.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a current wireless access technology.

FIG. 2 is a schematic diagram illustrating a wireless access system of the present disclosure.

FIG. 3 is a flow chart illustrating detailed steps of a step in FIG. 2 in some embodiments.

FIG. 4 is a schematic diagram illustrating a first vendor specific information element in some embodiments.

FIG. 5 is a flow chart illustrating detailed steps of another step in FIG. 2 in some embodiments.

FIG. 6 is a schematic diagram illustrating a second vendor specific information element in some embodiments.

FIG. 7 is a flow chart illustrating detailed steps of another step in FIG. 2 in some embodiments.

FIG. 8 is a flow chart illustrating detailed steps of another step in FIG. 2 in some embodiments.

FIG. 9 is a schematic diagram illustrating a third vendor specific information element in some embodiments.

FIG. 10 is a flow chart illustrating detailed steps of another step in FIG. 2 in some embodiments.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

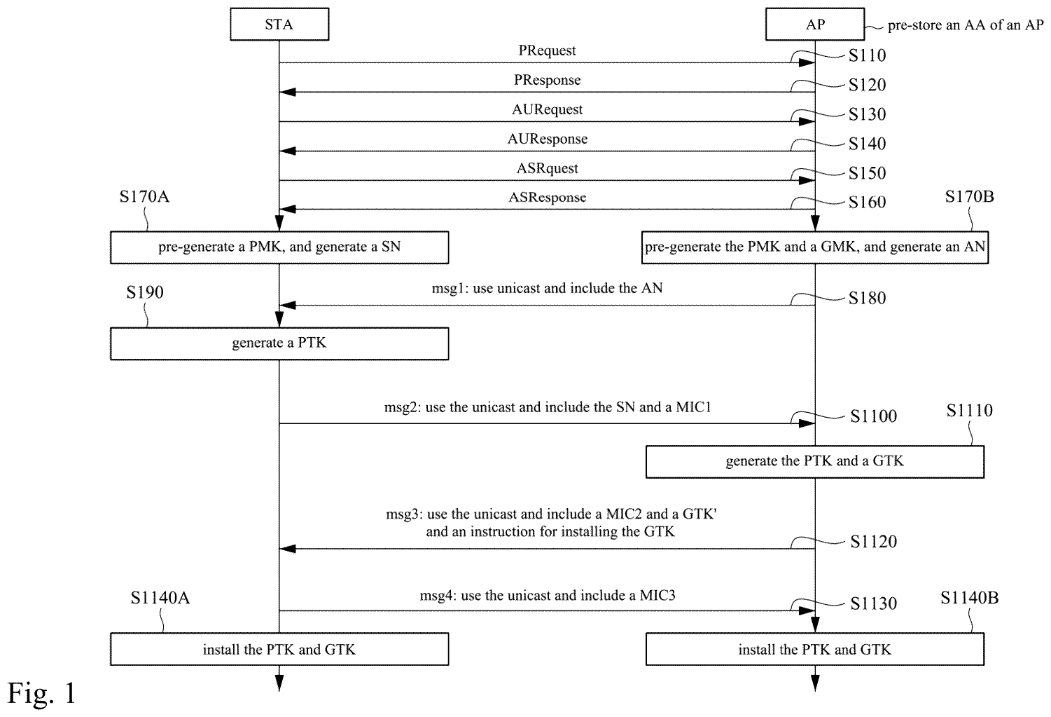

Reference is made to FIG. 1, which is a schematic diagram of a wireless access technology (e.g., Wi-Fi access technology) in an example. As shown in FIG. 1, in the wireless access technology of this example, when a terminal device STA (e.g., a mobile phone) intends to access an access point AP (e.g., a router) for wireless transmission, the terminal device STA first performs an association process and then perform key negotiation.

First, the association process stage comprises steps S110-S160. In the step S110, the terminal device STA broadcasts a probe request PRequest to detect whether an access point AP exists around the terminal device STA. In the step S120, when the access point AP receives the probe request PRequest, the access point AP transmits the probe response PResponse to the terminal device STA. In this way, the terminal device STA knows its neighboring access point AP according to the received probe response PResponse.

In the step S130, when the terminal device STA receives the probe response PResponse, the terminal device STA transmits an authentication request AURequest to the access point AP to request an authentication from the access point AP. In the step S140, when the access point AP receives the authentication request AURequest, the access point AP performs the authentication of the terminal device STA according to the authentication request AURequest and transmits an authentication response AUResponse to the terminal device STA when the authentication is successful, to proceed the subsequent association process.

In the step S150, when the terminal device STA receives the authentication response AUResponse, the terminal device STA transmits an association request ASRequest to the access point AP to notify the access point AP about the terminal device STA joining the communication (e.g., data transmitting/receiving). In the step S160, when the access point AP receives the association request ASRequest, the access point AP performs a word segment detection according to the association request ASRequest. When the detection is successful, the access point AP transmits an association response ASResponse to the terminal device STA to notify the terminal device STA that it has been allowed to join the communication. After the step S160 is completed, the terminal device STA and the access point AP enter the key negotiation stage.

Next, the key negotiation stage comprises steps S170A-S1140B. In the step S170A, the terminal device STA pre-generates a pairwise master key PMK and generates a supplicant nonce SN. In the step S170B, the access point AP pre-generates the pairwise master key PMK and a group master key GMK and generates an authenticator nonce AN. The pairwise master key PMK is configured to generate a pairwise transient key PTK for performing a unicast encryption and decryption, the group master key GMK is configured to generate a group transient key GTK, and the group transient key GTK is configured to perform a multicast encryption and decryption. In the step S180, the access point AP unicasts a first message msg1 to the terminal device STA, wherein the first message msg1 comprises the authenticator nonce AN. In the step S190, when the terminal device STA receives the first message msg1, the terminal device STA generates and stores the pairwise transient key PTK.

In the step S1100, the terminal device STA unicasts a second message msg2 to the access point AP, wherein the second message msg2 comprises the supplicant nonce SN generated by the terminal device STA and a message integrity code MIC1 of the second message msg2.

It is noted that, the terminal device STA extracts a part of the pairwise transient key as a key confirmation key (KCK) and performs a hash algorithm on data in the second message msg2 except the message integrity code MIC1 of the second message msg2 to generate the message integrity code MIC1. In this way, the message integrity code MIC1 is added to the second message msg2. Message integrity codes MIC2-MIC3 are also generated through the same method.

In the step S1110, when the access point AP receives the second message msg2, the access point AP generates the pairwise transient key PTK and the group transient key GTK.

It is noted that, the access point AP pre-stores an authenticator address AA and performs a hash algorithm on the group master key GMK, the authenticator address AA, and a group nonce GN to generate the group transient key GTK, wherein the authenticator address AA can be a media access control address (MAC address) of the access point AP.

In the step S1120, the access point AP unicasts a third message msg3 to the terminal device STA, wherein the third message msg3 comprises the message integrity code MIC2 of the third message msg3, an encrypted group transient key GTK′, and instructions for installing the group transient key GTK. In the step S1130, when the terminal device STA receives the third message msg3, the terminal device STA unicasts a fourth message msg4 to the access point AP, wherein the fourth message msg4 comprises the message integrity code MIC3 of the fourth message msg4.

In the step S1140A, the terminal device STA installs the pairwise transient key PTK and the group transient key GTK. In the step S1140B, the access point AP installs the pairwise transient key PTK and the group transient key GTK.

As the wireless access technology shown in FIG. 1, after 6 interactions in the association process stage (i.e., the steps S110-S160) and 4 handshakes in the key negotiation stage (i.e., the steps S180, S1100, S1120, and S1130), an encrypted transmission can be established. That is, as shown in FIG. 1, the terminal device STA and the access point AP need to establish the encrypted transmission through 10 message exchanges. Therefore, the establishment of each encrypted transmission requires complicated steps and lots of time, and it will greatly reduce the efficiency of establishing encrypted transmission. Also, it is hard to enter passwords due to lack of the visual input user interface of the terminal device STA.

Compared with the low efficiency of the wireless access or unable to perform wireless access owing to the complex steps of the example in FIG. 1, the present disclosure provides a wireless access method, applicable to the terminal device STA and the access point AP in the wireless access system, and the wireless access method can increase the efficiency of the wireless access. In some embodiments, the wireless access method of the present disclosure can establish an encrypted transmission through less message exchanges such as 3 message exchanges for transmitting a beacon, a probe request PRequest, and a probe response PResponse. Also, if the terminal device STA does not have a visual input user interface, the wireless access method of the present disclosure can also establish the encrypted transmission quickly, and the detailed method is illustrated in the following paragraphs.

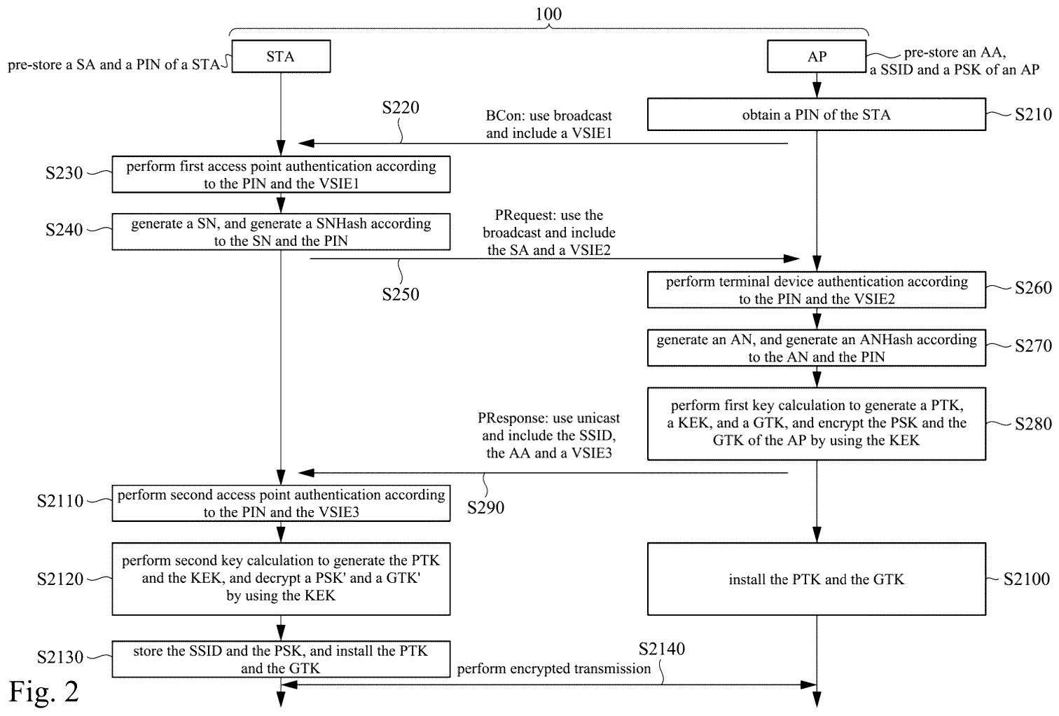

Reference is made to FIG. 2. FIG. 2 is a schematic diagram illustrating a wireless access system 100 of the present disclosure. As shown in FIG. 2, the wireless access system 100 comprises a terminal device STA and an access point AP. The access point AP is configured to provide wireless access function and store a service set identifier SSID, a pre-shared key PSK, and an authenticator address AA of the access point AP. The terminal device STA is configured to wirelessly access the access point AP and store a supplicant address SA and a personal identification number PIN of the terminal device STA. In some embodiments, the personal identification number PIN of the terminal device STA can be set by the manufacturer during manufacturing the terminal device STA.

In some embodiments, the access point AP can store the password of the wireless access, and the password can be a preset password or customized by users.

In some embodiments, the authenticator address AA and the supplicant address SA can be the media access control address of the access point AP and the media access control address of the terminal device STA respectively. In some embodiments, the terminal device STA can be any electronic device with wireless transceiving function and supporting the wireless access function of the present disclosure. For example, the terminal device STA can be a mobile device (e.g., mobile phone, smartwatch, etc.) or an IoT device supporting the wireless access function of the present disclosure. The access point AP can be any access point supporting the wireless access function of the present disclosure, such as a router or a network node supporting the wireless access function of the present disclosure.

In some embodiments, the personal identification number PIN of the terminal device STA can be a string comprising any numbers and characters. The string can be of any length, and there are no limits on the composition of the string and the length of the string. Therefore, compared with the personal identification number of the current Wi-Fi protected setup (WPS), the personal identification number PIN of the terminal device STA of the present disclosure is not limited to the format of string of 8 decimal digits. This allows the manufacturer customizing the personal identification number and avoids the personal identification number of the prior art being reused due to insufficient quantity.

First, in the step S210, the access point AP obtains the personal identification number PIN of the terminal device STA. In some embodiments, the user can input the personal identification number PIN of the terminal device STA wirelessly accessing the access point AP in the visual input user interface of the access point AP.

In the step S220, the access point AP broadcasts a beacon BCon comprising a first vendor Specific information element (VSIE) VSIE1. In this embodiment, the first vendor Specific information element VSIE1 can comprise a vendor organizationally unique identifier (vendor OUI), a device status, the message integrity code, and other contents. In some embodiments, the access point AP can take the personal identification number PIN of the terminal device STA as a passphrase to perform a hash algorithm on the first vendor specific information element VSIE1 to generate the message integrity code of the first vendor specific information element VSIE1. In some embodiments, the hash algorithm can be the HMAC-SHA1 algorithm.

It is noticed that, the vendor specific information element in the present disclosure can be a custom field for packet set by IEEE 802.11 protocol, and the custom field is an optional field provided to manufacturers or users.

In the step S230, the terminal device STA receives the beacon BCon comprising the first vendor specific information element VSIE1 from the access point AP and perform a first access point authentication according to the personal identification number PIN of the terminal device STA and the first vendor specific information element VSIE1.

In some embodiments, the first access point authentication can be an authentication on the message integrity code of the first vendor specific information element VSIE1 in the beacon BCon.

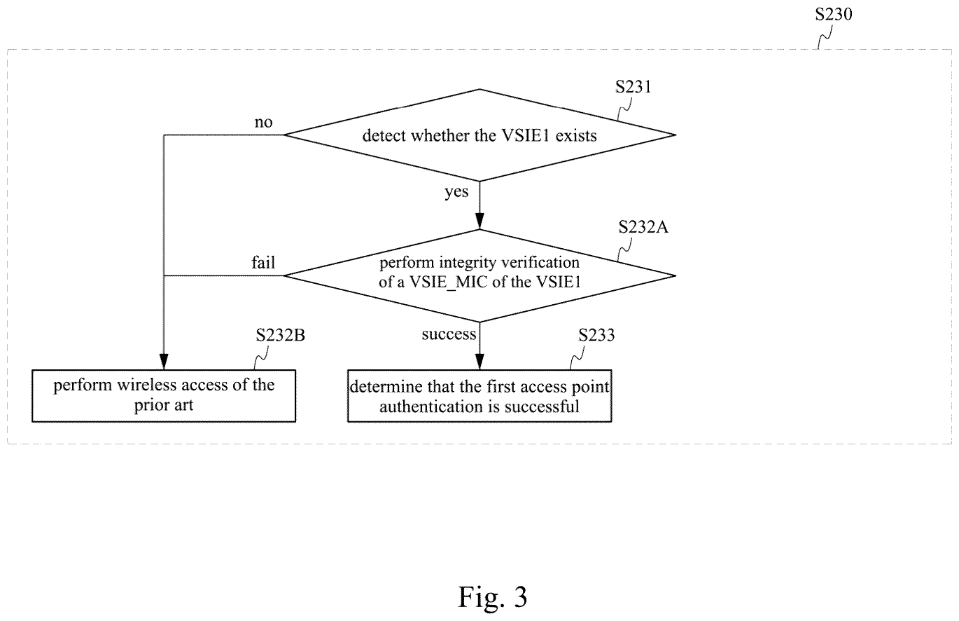

Reference is further made to FIG. 3. FIG. 3 is a flow chart illustrating detailed steps of the step S230 in FIG. 2 in some embodiments. As shown in FIG. 3, the step S230 comprises S231-S233.

In the step S231, when the terminal device STA receives the beacon BCon, the terminal device STA detects whether the first vendor specific information element VSIE1 exists. In some embodiments, when the first vendor specific information element VSIE1 exists, the step S232A is executed. Otherwise, the step S232B is executed.

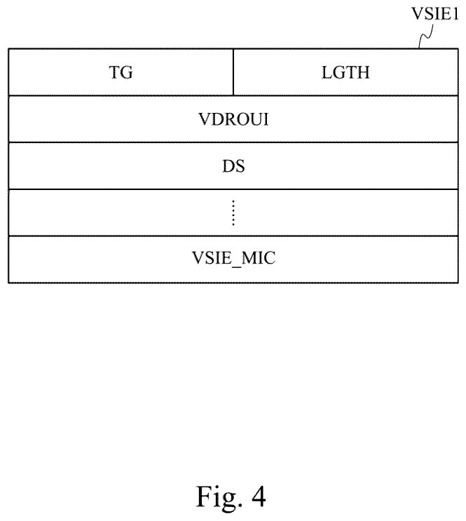

Reference is further made to FIG. 4. FIG. 4 is a schematic diagram illustrating the first vendor specific information element VSIE1 in some embodiments. As shown in FIG. 4, the first vendor specific information element VSIE1 comprises a tag TG, a length LGTH, and a manufacturer customized element content. The manufacturer customized element content can comprise a vendor organizationally unique identifier VDROUI, a device status DS, the message integrity code VSIE_MIC, and other contents.

Specifically, the tag TG is a label of a field of the vendor specific information element. The length LGTH is a byte length of the field of the vendor specific information element. The vendor organizationally unique identifier VDROUI is information related to the manufacturer of the access point AP. The device status DS is a device status indicating the access point AP being in the beacon BCon broadcasting status. The message integrity code VSIE_MIC is an integrity verification value of element contents of the field of the vendor specific information element.

In other words, when the terminal device STA detects that the first vendor specific information element VSIE1 comprises the tag TG, the length LGTH, the vendor organizationally unique identifier VDROUI, the device status DS, the message integrity code VSIE_MIC, and other contents, the terminal device STA can determine that the first vendor specific information element VSIE1 exists. Otherwise, the terminal device STA determines that the first vendor specific information element VSIE1 does not exist.

As shown in FIG. 3, in the step S232A, the terminal device STA performs an integrity verification of the first vendor specific information element VSIE1 by using the message integrity code VSIE_MIC of the first vendor specific information element VSIE1 and the personal identification number PIN. When the integrity verification is successful, the step S233 is executed. Otherwise, the step S232B is executed.

In the step S232B, the terminal device STA and the access point AP start to perform the wireless access of the prior art (e.g., the wireless access shown in FIG. 1).

In some embodiments, the terminal device STA can generate a message integrity code for the verification according to the first vendor specific information element VSIE1 and the personal identification number PIN. Next, the terminal device STA can compare the message integrity code VSIE_MIC of the first vendor specific information element VSIE1 with the message integrity code for the verification. When the terminal device STA determines that the message integrity code VSIE_MIC of the first vendor specific information element VSIE1 is the same as the message integrity code for the verification (e.g., the values are equal), the terminal device STA can determine that the integrity verification of the first vendor specific information element VSIE1 is successful. Otherwise, the terminal device STA can determine that the integrity verification of the first vendor specific information element VSIE1 is failed.

In some embodiments, the terminal device STA can take the personal identification number PIN as a passphrase to perform a hash algorithm on data in the first vendor specific information element VSIE1 except the message integrity code VSIE_MIC of the first vendor specific information element VSIE1, so as to generate the message integrity code for the verification. In some embodiments, the hash algorithm can be the HMAC-SHA1 algorithm.

In the step S233, the terminal device STA determines that the first access point authentication is successful, and the step S240 is executed.

As shown in FIG. 2, in the step S240, the terminal device STA generates the supplicant nonce SN and generates a supplicant nonce hash value SNHash according to the supplicant nonce SN and the personal identification number PIN.

In some embodiments, the terminal device STA can generate a random number as the supplicant nonce SN.

In some embodiments, the terminal device STA can take the personal identification number PIN as a passphrase to perform a hash algorithm on the supplicant nonce SN to generate the supplicant nonce hash value SNHash. In some embodiments, the hash algorithm can be the SHA1_PRF algorithm.

In the step S250, the terminal device STA can broadcast a probe request PRequest comprising a second vendor specific information element VSIE2 and the supplicant address SA of the terminal device STA. In this embodiment, the second vendor specific information element VSIE2 comprises a vendor organizationally unique identifier, a device status, a device capability, the supplicant nonce SN, the supplicant nonce hash value SNHash, a message integrity code of the second vendor specific information element, and other contents. In some embodiments, the terminal device STA can take the personal identification number PIN as a passphrase to perform a hash algorithm on the second vendor specific information element VSIE2 to generate the message integrity code of the second vendor specific information element VSIE2. In some embodiments, the hash algorithm can be the HMAC-SHA1 algorithm.

In the step S260, the access point AP receives the probe request PRequest from the terminal device STA and performs a terminal device authentication according to the personal identification number PIN of the terminal device STA and the second vendor specific information element VSIE2.

In some embodiments, the terminal device authentication can authenticate the message integrity code of the second vendor specific information element VSIE2 and the supplicant nonce hash value SNHash.

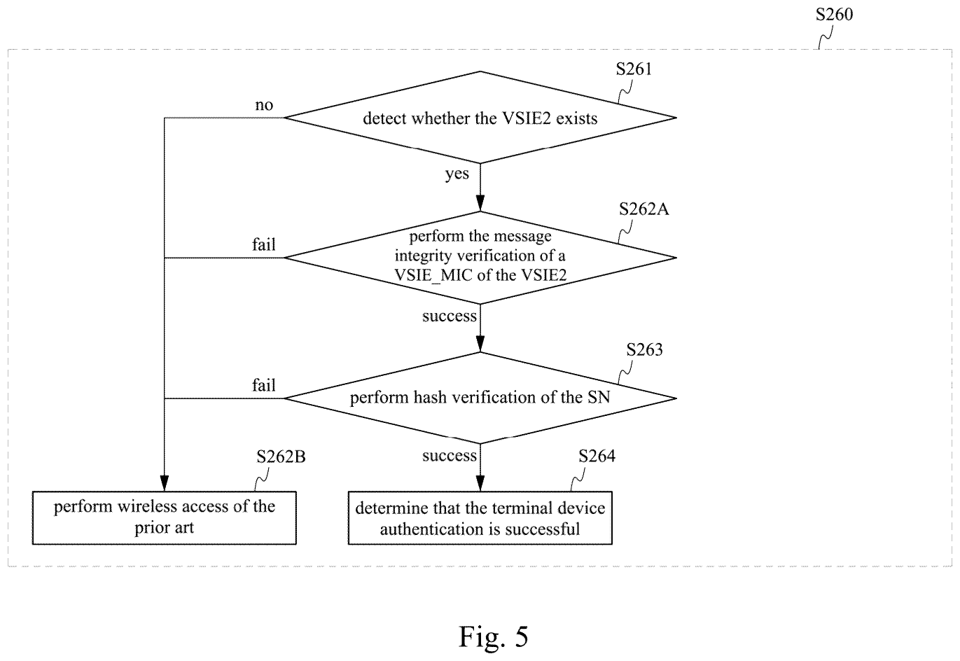

Reference is also made to FIG. 5. FIG. 5 is a flow chart illustrating detailed steps of the step S260 in FIG. 2 in some embodiments. As shown in FIG. 5, the step S260 comprises steps S261-S264.

In the step S261, when the access point AP receives the probe request PRequest, the access point AP detects whether the second vendor specific information element VSIE2 exists. In some embodiments, when the second vendor specific information element VSIE2 exists, the step S262A is executed. Otherwise, the step S262B is executed.

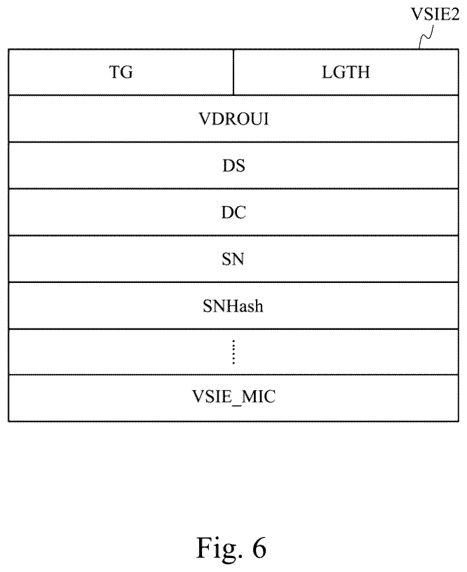

Reference is also made to FIG. 6. FIG. 6 is a schematic diagram illustrating the second vendor specific information element VSIE2 in some embodiments. As shown in FIG. 6, the second vendor specific information element VSIE2 comprises the tag TG, the length LGTH, the vendor organizationally unique identifier VDROUI, the device status DS, the device capability DC, the supplicant nonce SN, the supplicant nonce hash value SNHash, the message integrity code VSIE_MIC, and other contents.

Compared with the first vendor specific information element VSIE1, the second vendor specific information element VSIE2 further comprises the supplicant nonce SN and the supplicant nonce hash value SNHash. Also, the vendor organizationally unique identifier VDROUI is information related to the manufacturer of the terminal device STA. The device status DS is a device status indicating the terminal device STA being in the probe request PRequest broadcasting status. The device capability DC is capability information indicating the terminal device STA being in the probe request PRequest broadcasting status.

In other words, when the access point AP detects that the second vendor specific information element VSIE2 comprises the tag TG, the length LGTH, the vendor organizationally unique identifier VDROUI, the device status DS, the device capability DC, the supplicant nonce SN, the supplicant nonce hash value SNHash, the message integrity code VSIE_MIC, and other contents, the access point AP can determine that the second vendor specific information element VSIE2 exists. Otherwise, the access point AP can determine that the second vendor specific information element VSIE2 does not exist.

As shown in FIG. 5, in the step S262A, the access point AP performs an integrity verification of the second vendor specific information element VSIE2 by using the message integrity code VSIE_MIC of the second vendor specific information element VSIE2 and the personal identification number PIN of the terminal device STA. When the integrity verification is successful, the step S263 is executed. Otherwise, the step S262B is executed.

In some embodiments, the access point AP can generate a message integrity code for the verification according to the second vendor specific information element VSIE2 and the personal identification number PIN. Next, the access point AP can compare the message integrity code VSIE_MIC of the second vendor specific information element VSIE2 with the message integrity code for the verification. Next, when the access point AP determines that the message integrity code VSIE_MIC of the second vendor specific information element VSIE2 is the same as the message integrity code for the verification (e.g., the values are equal), the access point AP can determine that the integrity verification of the second vendor specific information element VSIE2 is successful. Otherwise, the access point AP can determine that the integrity verification of the second vendor specific information element VSIE2 is failed.

In some embodiments, the access point AP can take the personal identification number PIN as a passphrase to perform a hash algorithm on data in the second vendor specific information element VSIE2 except the message integrity code VSIE_MIC of the second vendor specific information element VSIE2, so as to generate the message integrity code for the verification. In some embodiments, the hash algorithm can be the HMAC-SHA1 algorithm.

In the step S262B, the terminal device STA and the access point AP start to perform the wireless access of the prior art (e.g., the wireless access shown in FIG. 1).

In the step S263, the access point AP performs a hash verification of the supplicant nonce SN by using the supplicant nonce hash value SNHash and the personal identification number PIN of the terminal device STA. When the hash verification is successful, the step S264 is executed. Otherwise, the step S262B is executed.

In some embodiments, the access point AP can generate the supplicant nonce hash value for the verification according to the supplicant nonce SN and the personal identification number PIN. Next, the access point AP can compare the supplicant nonce hash value SNHash received with the supplicant nonce hash value for the verification. When the access point AP determines that the supplicant nonce hash value SNHash is the same as the supplicant nonce hash value for the verification, the access point AP can determine that the hash verification is successful. Otherwise, the access point AP can determine that the hash verification is failed.

In some embodiments, the access point AP can take the personal identification number PIN as a passphrase to perform a hash algorithm on the supplicant nonce SN to generate the supplicant nonce hash value for the verification. In some embodiments, the hash algorithm can be the SHA1_PRF algorithm.

In the step S264, the access point AP determines that the terminal device authentication is successful, and the step S270 is executed.

As shown in FIG. 2, in the step S270, the access point AP generates an authenticator nonce AN and generates an authenticator nonce hash value ANHash according to the authenticator nonce AN and the personal identification number PIN of the terminal device STA.

In some embodiments, the access point AP can generate a random number as the authenticator nonce AN.

In some embodiments, the access point AP can take the personal identification number PIN of the terminal device STA as a passphrase to perform a hash algorithm on the authenticator nonce AN to generate the authenticator nonce hash value ANHash. In some embodiments, the hash algorithm can be the SHA1_PRF algorithm.

In the step S280, the access point AP performs a first key calculation to generate a pairwise transient key PTK, a group transient key GTK, and a key encryption key KEK and encrypts the pre-shared key PSK of the access point AP and the group transient key GTK by using a key encryption key KEK. In some embodiments, the key encryption key is configured to encrypt a key.

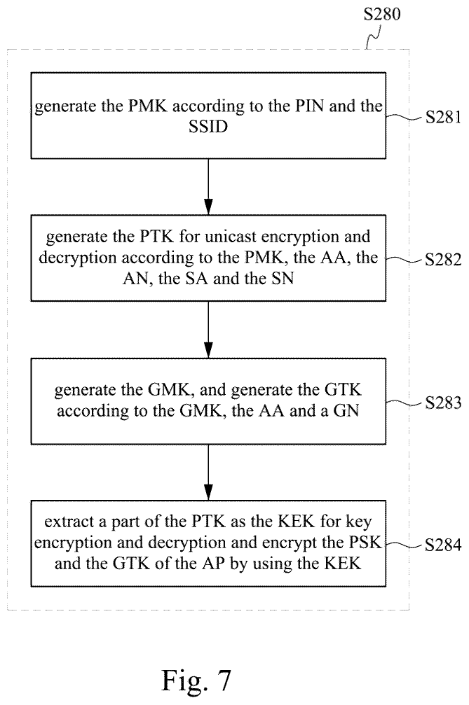

Reference is also made to FIG. 7. FIG. 7 is a flow chart illustrating detailed steps of the step S280 in FIG. 2 in some embodiments. FIG. 7 illustrates detailed steps of the first key calculation. As shown in FIG. 7, the step S280 comprises steps S281-S284.

In the step S281, the access point AP generates the pairwise master key PMK according to the personal identification number PIN of the terminal device STA and a service set identifier SSID of the access point AP. In some embodiments, the access point AP can take the personal identification number PIN of the terminal device STA as a passphrase to perform a hash algorithm on the service set identifier SSID to generate the pairwise master key PMK. In some embodiments, the hash algorithm can be the pdkdf2_SHA1 algorithm.

In the step S282, the access point AP generates the pairwise transient key PTK configured to perform a unicast encryption and decryption according to the pairwise master key PMK, the authenticator address AA, the authenticator nonce AN, the supplicant address SA, and the supplicant nonce SN.

In some embodiments, the access point AP can take the pairwise master key PMK as a passphrase to perform a hash algorithm on the supplicant address SA, the authenticator address AA, the authenticator nonce AN, and the supplicant nonce SN to generate the pairwise transient key PTK configured to perform the unicast encryption and decryption. In some embodiments, the hash algorithm can be the SHA1_PRF algorithm.

In the step S283, if the access point AP has not generated the group transient key GTK, the access point AP generates the group master key GMK and generates the group transient key GTK according to the group master key GMK, the authenticator address AA, and the group nonce GN.

The group master key GMK is an auxiliary key configured to generate the group transient key GTK. In some embodiments, the group master key GMK of the access point AP can be a string with all 0s in the string. In some embodiments, the access point AP performs a hash algorithm on the group master key GMK, the authenticator address AA, and the group nonce GN to generate the group transient key GTK configured to perform a broadcast encryption and decryption. In some embodiments, the hash algorithm can be the SHA1_PRF algorithm. In some embodiments, the method of generating the group nonce GN can be the same as the method of generating the authenticator nonce AN and the supplicant nonce SN. The group nonce GN differs from the authenticator nonce AN and the supplicant nonce SN only in that the group nonce GN is only used in the access point AP.

In the step S284, the access point AP extracts a part of the pairwise transient key PTK as the key encryption key KEK configured to perform a key encryption and decryption and encrypts the pre-shared key PSK and the group transient key GTK of the access point AP by using the key encryption key KEK, and the step S290 is executed. For example, when the data length of the pairwise transient key PTK is 512 bytes, the access point AP can take the 129th-256th bytes of the pairwise transient key PTK as the key encryption key KEK. In some embodiments, the access point AP can perform the Advanced Encryption Standard (AES) algorithm by using the key encryption key KEK as an encryption key of the pre-shared key PSK and the group transient key GTK to generate the encrypted pre-shared key PSK′ and the encrypted group transient key GTK′.

As shown in FIG. 2, in the step S290, the access point AP transmits the probe response PResponse comprising the third vendor specific information element VSIE3, the service set identifier SSID, and the authenticator address AA to the terminal device STA. In this embodiment, the third vendor specific information element VSIE3 comprises the vendor organizationally unique identifier, the device status, the device capability, the authenticator nonce AN, the authenticator nonce hash value ANHash, the encrypted pre-shared key PSK′, the encrypted group transient key GTK′, the message integrity code, and other contents. In this embodiment, the access point AP can take the personal identification number PIN of the terminal device STA as a passphrase to perform a hash algorithm on the third vendor specific information element VSIE3 to generate the message integrity code of the third vendor specific information element VSIE3. In some embodiments, the hash algorithm can be the HMAC-SHA1 algorithm.

In the step S2100, the access point AP installs the pairwise transient key PTK and the group transient key GTK.

In the step S2110, the terminal device STA receives the probe response PResponse comprising the third vendor specific information element VSIE3 from the access point AP and performs a second access point authentication according to the personal identification number PIN and the third vendor specific information element VSIE3.

In this embodiment, the second access point authentication can be an authentication on the message integrity code VSIE_MIC of the third vendor specific information element VSIE3 and the authenticator nonce hash value ANHash.

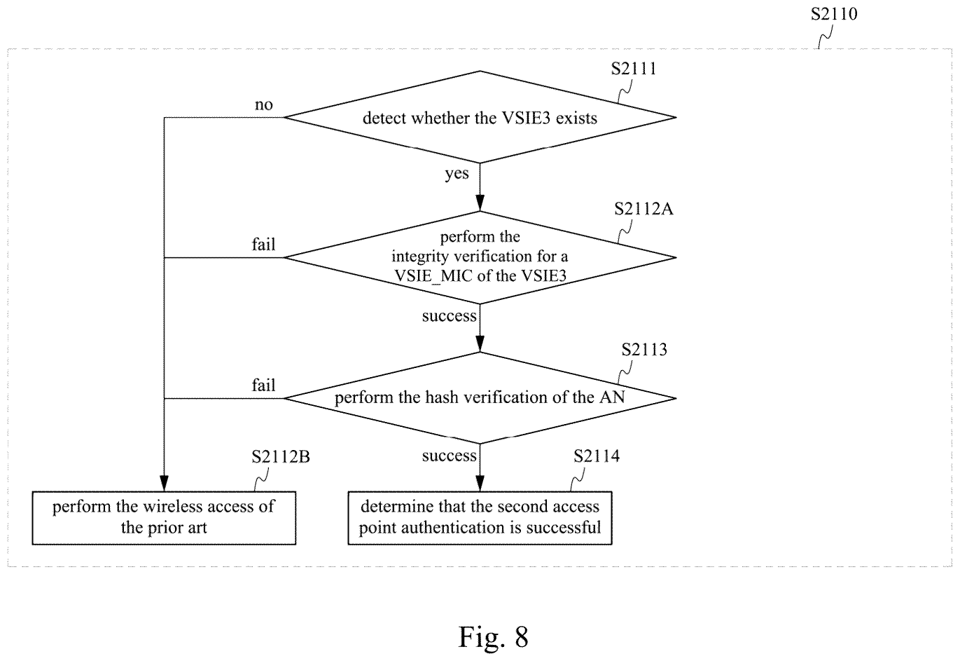

Reference is also made to FIG. 8. FIG. 8 is a flow chart illustrating detailed steps of the step S2110 in FIG. 2 in some embodiments. As shown in FIG. 8, the step S2110 comprises steps S2111-S2114.

In the step S2111, when the terminal device STA receives the probe response PResponse, the terminal device STA detects whether the third vendor specific information element VSIE3 exists. In some embodiments, when the third vendor specific information element VSIE3 exists, the step S2112A is executed. Otherwise, the step S2112B is executed.

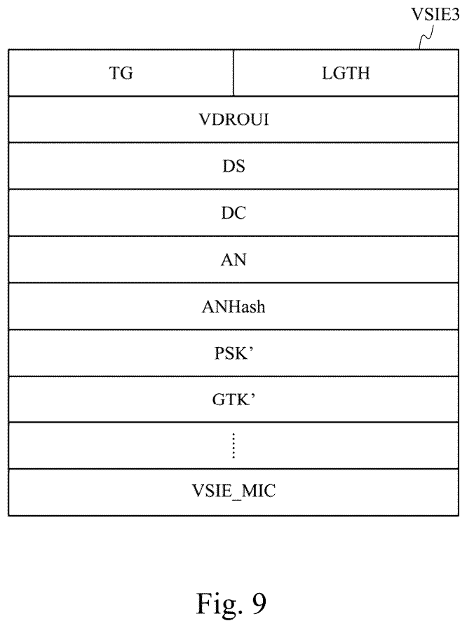

Reference is also made to FIG. 9. FIG. 9 is a schematic diagram illustrating the third vendor specific information element VSIE3 in some embodiments. As shown in FIG. 9, the third vendor specific information element VSIE3 comprises the tag TG, the length LGTH, the vendor organizationally unique identifier VDROUI, the device status DS, the device capability DC, the authenticator nonce AN, the authenticator nonce hash value ANHash, the encrypted pre-shared key PSK′, the encrypted group transient key GTK′, the message integrity code VSIE_MIC, and other contents.

Compared with the second vendor specific information element VSIE2, the third vendor specific information element VSIE3 further comprises the authenticator nonce AN, the authenticator nonce hash value ANHash, the encrypted pre-shared key PSK′, and the encrypted group transient key GTK′. Also, the vendor organizationally unique identifier VDROUI is information related to the manufacturer of the access point AP. The device status DS is a device status indicating the access point AP being in the probe response PResponse transmission status. The device capability DC is capability information indicating the access point AP being in the probe response PResponse transmission status.

In other words, when the terminal device STA detects that the third vendor specific information element VSIE3 comprises the tag TG, the length LGTH, the vendor organizationally unique identifier VDROUI, the device status DS, the device capability DC, the authenticator nonce AN, the authenticator nonce hash value ANHash, the encrypted pre-shared key PSK′, and the encrypted group transient key GTK′, the message integrity code VSIE_MIC, and other contents, the terminal device STA can determine that the third vendor specific information element VSIE3 exists. Otherwise, the terminal device STA can determine that the third vendor specific information element VSIE3 does not exist.

As shown in FIG. 8, in the step S2112A, the terminal device STA performs an integrity verification of the third vendor specific information element VSIE3 by using the message integrity code VSIE_MIC of the third vendor specific information element VSIE3 and the personal identification number PIN. When the integrity verification is successful, the step S2113 is executed. Otherwise, the step S2112B is executed.

In some embodiments, the terminal device STA can take the personal identification number PIN as a passphrase to perform a hash algorithm on data in the third vendor specific information element VSIE3 except the message integrity code VSIE_MIC of the third vendor specific information element VSIE3, so as to generate the message integrity code for the verification. Next, the terminal device STA can compare the message integrity code VSIE_MIC of the third vendor specific information element VSIE3 with the message integrity code for the verification. Next, when the terminal device STA determines that the message integrity code VSIE_MIC of the probe response PResponse is the same as the message integrity code for the verification (e.g., the values are equal), the terminal device STA can determine that the integrity verification of the third vendor specific information element VSIE3 is successful. Otherwise, the terminal device STA can determine that the integrity verification is failed.

In the step S2112B, the terminal device STA and the access point AP start to perform the wireless access of the prior art (e.g., the wireless access shown in FIG. 1).

In the step S2113, the terminal device STA performs a hash verification of the authenticator nonce AN by using the authenticator nonce hash value ANHash and the personal identification number PIN. When the hash verification is successful, the step S2114 is executed. Otherwise, the step S2112B is executed.

In some embodiments, the terminal device STA can generate the authenticator nonce hash value for the verification according to the authenticator nonce AN and the personal identification number PIN. Next, the terminal device STA can compare the authenticator nonce hash value ANHash received with the authenticator nonce hash value for the verification. When the terminal device STA determines that the authenticator nonce hash value ANHash is the same as the authenticator nonce hash value for the verification, the terminal device STA can determine that the hash verification is successful. Otherwise, the terminal device STA can determine that the hash verification is failed.

In some embodiments, the terminal device STA take the personal identification number PIN as a passphrase to perform a hash algorithm on the authenticator nonce AN to generate the authenticator nonce hash value for the verification. In some embodiments, the hash algorithm can be the SHA1_PRF algorithm.

In the step S2114, the terminal device STA determines that the second access point authentication is successful, and the step S2120 is executed.

As shown in FIG. 2, in the step S2120, the terminal device STA performs a second key calculation to generate a pairwise transient key PTK and a key encryption key KEK and decrypts the encrypted pre-shared key PSK′ and the encrypted group transient key GTK′ by using the key encryption key KEK.

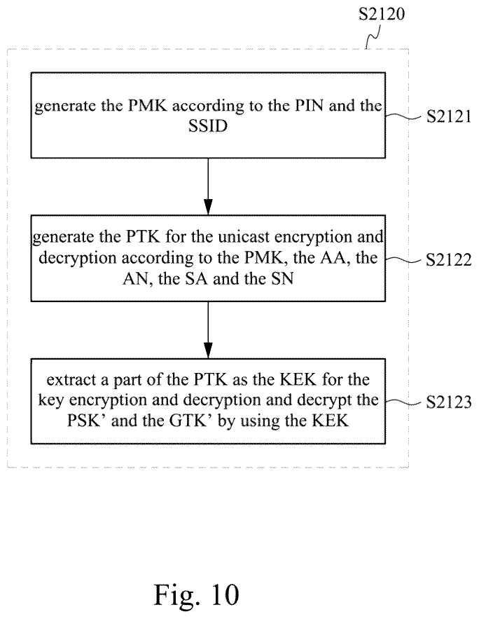

Reference is also made to FIG. 10. FIG. 10 is a flow chart illustrating detailed steps of the step S2120 in FIG. 2 in some embodiments. FIG. 10 illustrates detailed steps of the second key calculation. As shown in FIG. 10, the step S2120 comprises steps S2121-S2123.

In the step S2121, the terminal device STA generates a pairwise master key PMK according to the personal identification number PIN and the service set identifier SSID. In some embodiments, the terminal device STA can take the personal identification number PIN as a passphrase to perform a hash algorithm on the service set identifier SSID to generate the pairwise master key PMK. In some embodiments, the hash algorithm can be the pdkdf2_SHA1 algorithm.

In the step S2122, the terminal device STA generates a pairwise transient key PTK configured to perform a unicast encryption and decryption according to the pairwise master key PMK, the authenticator address AA, the authenticator nonce AN, the supplicant address SA, and the supplicant nonce SN.

In some embodiments, the terminal device STA can take the pairwise master key PMK as a passphrase to perform a hash algorithm on the supplicant address SA, the authenticator address AA, the authenticator nonce AN, and the supplicant nonce SN to generate the pairwise transient key PTK configured to perform the unicast encryption and decryption. In some embodiments, the hash algorithm can be the SHA1_PRF algorithm.

In the step S2123, the terminal device STA extracts a part of the pairwise transient key PTK as the key encryption key KEK configured to perform a key encryption and decryption and decrypts the encrypted pre-shared key PSK′ and the encrypted group transient key GTK′ by using the key encryption key KEK, and the step S2130 is executed.

In some embodiments, the terminal device STA can perform the Advanced Encryption Standard algorithm by using the key encryption key KEK as a decryption key of the encrypted pre-shared key PSK′ and the encrypted group transient key GTK′ to obtain the pre-shared key PSK and the group transient key GTK (i.e., decrypting through the Advanced Encryption Standard algorithm).

As shown in FIG. 2, in the step S2130, the terminal device STA stores the service set identifier SSID and the pre-shared key PSK and installs the pairwise transient key PTK and the group transient key GTK. Meanwhile, the terminal device STA and the access point AP will install the same pairwise transient key PTK and the same group transient key GTK to perform an encrypted transmission by using the pairwise transient key PTK and the group transient key GTK.

By the operations above, the wireless access method provided by the present disclosure can directly complete the association stage and the key negotiation stage of the general wireless access technology through 3 simple interactions after the personal identification number PIN of the terminal device STA is inputted into the access point AP, so as to establish the encrypted transmission between the access point AP and the terminal device STA.

In summary, as long as a personal identification number of a terminal device is inputted into an access point, the wireless access method of the present disclosure can establish an encrypted transmission after 3 simple interactions are completed. Also, the wireless access method of the present disclosure only needs 1 beacon, 1 probe request, and 1 probe response in the prior art to establish an encrypted transmission. Additionally, different from the generation method of the pairwise master key, the generation method of the message integrity code, and method of the hash verification in the prior art, the present disclosure generates a pairwise master key, a message integrity code, and a hash value by using a personal identification number and verifies the message integrity code and the hash value by using the personal identification number to put verification information and key information in a vendor specific information element. In this way, the complicated association stage and the complicated key negotiation stage in the prior art can be shorten to 3 interactions, and the encrypted transmission can be established afterwards. When the terminal device does not have a visual input user interface, the wireless access method of the present disclosure does not need to input the password to the terminal device to quickly establish the encrypted transmission. Besides, the terminal device and the access point of the present disclosure can only have the basic wireless access function (e.g., Wi-Fi) and without adding hardware or software functions to establish the encrypted transmission. It is noticed that, the high scalability of the personal identification number provided by the present disclosure can avoid the personal identification number of the prior art being reused due to insufficient quantity.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A wireless access method, comprising:
(a) obtaining, by an access point, a personal identification number of a terminal device and broadcasting, by the access point, a beacon comprising a first vendor specific information element;
(b) receiving, by the access point, a probe request from the terminal device comprising a second vendor specific information element and performing, by the access point, a terminal device authentication on the second vendor specific information element according to the personal identification number;
(c) when the terminal device authentication is successful, performing, by the access point, a key calculation according to the personal identification number and the probe request to generate a pairwise transient key, a key encryption key, and a group transient key and encrypting, by the access point, a pre-shared key and the group transient key of the access point by using the key encryption key to generate an encrypted pre-shared key and an encrypted group transient key;
(d) transmitting, by the access point, a probe response comprising a third vendor specific information element to the terminal device, wherein the third vendor specific information element comprises the encrypted pre-shared key and the encrypted group transient key; and
(e) installing, by the access point, the pairwise transient key and the group transient key to establish an encrypted transmission.

2. The wireless access method of claim 1, wherein the step (a) comprises:
taking, by the access point, the personal identification number as a passphrase to perform a first hash algorithm on the first vendor specific information element in the beacon to generate a message integrity code of the first vendor specific information element.

3. The wireless access method of claim 1, wherein the second vendor specific information element comprises a message integrity code of the second vendor specific information element, and a supplicant nonce and a supplicant nonce hash value generated by the terminal device, wherein the step (b) comprises:
(b1) when the probe request is received, detecting, by the access point, whether the second vendor specific information element exists;
(b2) when the second vendor specific information element exists, performing, by the access point, an integrity verification of the second vendor specific information element by using the message integrity code of the second vendor specific information element and the personal identification number;
(b3) when the integrity verification is successful, performing, by the access point, a hash verification of the supplicant nonce by using the supplicant nonce hash value and the personal identification number; and
(b4) when the hash verification is successful, determining, by the access point, that the terminal device authentication is successful.

4. The wireless access method of claim 3, wherein the step (b2) comprises:
(b21) generating, by the access point, the message integrity code for a verification according to the second vendor specific information element and the personal identification number;
(b22) comparing, by the access point, the message integrity code of the second vendor specific information element and the message integrity code for the verification; and
(b23) when the message integrity code of the second vendor specific information element is the same as the message integrity code for the verification, determining, by the access point, that the integrity verification of the second vendor specific information element is successful.

5. The wireless access method of claim 4, wherein the step (b21) comprises:
taking, by the access point, the personal identification number as a passphrase to perform a second hash algorithm on data in the second vendor specific information element except the message integrity code of the second vendor specific information element, so as to generate the message integrity code for the verification.

6. The wireless access method of claim 3, wherein step (b3) comprises:
(b31) generating, by the access point, the supplicant nonce hash value for a verification according to the supplicant nonce and the personal identification number;
(b32) comparing, by the access point, the supplicant nonce hash value and the supplicant nonce hash value for the verification; and
(b33) when the supplicant nonce hash value is the same as the supplicant nonce hash value for the verification, determining, by the access point, that the hash verification is successful.

7. The wireless access method of claim 6, wherein the step (b31) comprises:
taking, by the access point, the personal identification number as a passphrase to perform a third hash algorithm on the supplicant nonce to generate the supplicant nonce hash value for the verification.

8. The wireless access method of claim 1, wherein the key encryption key is configured to perform a key encryption and decryption, the pairwise transient key is configured to perform a unicast encryption and decryption, the group transient key is configured to perform a broadcast encryption and decryption, the probe request further comprises a supplicant address of the terminal device, and the step (c) comprises:
(c1) generating, by the access point, a pairwise master key according to the personal identification number and a service set identifier of the access point;
(c2) generating, by the access point, the pairwise transient key according to the pairwise master key, the supplicant address of the terminal device, an authenticator address, an authenticator nonce, and a supplicant nonce;
(c3) generating, by the access point, a group master key and generating the group transient key according to the group master key, the authenticator address and a group nonce; and
(c4) extracting, by the access point, a part of the pairwise transient key as the key encryption key.

9. The wireless access method of claim 8, wherein the step (c1) comprises:
taking, by the access point, the personal identification number as a first passphrase to perform a fourth hash algorithm on the service set identifier, so as to generate the pairwise master key, wherein the step (c2) comprises:
taking, by the access point, the pairwise master key as a second passphrase to perform a fifth hash algorithm on the supplicant address, the authenticator address, the authenticator nonce and the supplicant nonce, so as to generate the pairwise transient key, wherein the step (c3) comprises:
generating, by the access point, the group master key and taking, by the access point, the group master key as a third passphrase to perform a sixth hash algorithm on the authenticator address and the group nonce, so as to generate the group transient key.

10. The wireless access method of claim 1, wherein the step (d) comprises:
taking, by the access point, the personal identification number as a passphrase to perform a seventh hash algorithm on the third vendor specific information element in the probe response, so as to generate a message integrity code of the third vendor specific information element.

11. A wireless access method, comprising:
(a) receiving, by a terminal device, a beacon from an access point comprising a first vendor specific information element and performing, by the terminal device, a first access point authentication on the first vendor specific information element according to a personal identification number of the terminal device;
(b) when the first access point authentication is successful, broadcasting, by the terminal device, a probe request comprising a second vendor specific information element;
(c) receiving, by the terminal device, a probe response comprising a third vendor specific information element from the access point and performing, by the terminal device, a second access point authentication on the third vendor specific information element according to the personal identification number, wherein the third vendor specific information element comprises an encrypted pre-shared key and an encrypted group transient key;
(d) when the second access point authentication is successful, performing, by the terminal device, a key calculation according to the personal identification number and the probe response to generate a pairwise transient key and a key encryption key and decrypting, by the terminal device, the encrypted pre-shared key and the encrypted group transient key by using the key encryption key; and
(e) storing, by the terminal device, a pre-shared key and installing, by the terminal device, the pairwise transient key and the group transient key.

12. The wireless access method of claim 11, wherein the step (b) comprises:
taking, by the terminal device, the personal identification number as a passphrase to perform a first hash algorithm on the second vendor specific information element in the probe request, so as to generate a message integrity code of the second vendor specific information element.

13. The wireless access method of claim 11, wherein the first vendor specific information element further comprises a message integrity code of the first vendor specific information element, wherein the step (a) comprises:
(a1) when the beacon is received, detecting, by the terminal device, whether the first vendor specific information element exists;
(a2) when the first vendor specific information element exists, performing, by the terminal device, an integrity verification of the first vendor specific information element by using the message integrity code of the first vendor specific information element and the personal identification number; and
(a3) when the integrity verification is successful, determining, by the terminal device, that the first access point authentication is successful.

14. The wireless access method of claim 13, wherein the step (a2) comprises:
(a21) generating, by the terminal device, the message integrity code for a verification according to the first vendor specific information element and the personal identification number;
(a22) comparing, by the terminal device, the message integrity code of the first vendor specific information element and the message integrity code for the verification; and
(a23) when the message integrity code of the first vendor specific information element is the same as the message integrity code for the verification, determining, by the terminal device, that the integrity verification of the first vendor specific information element is successful.

15. The wireless access method of claim 14, wherein the step (a21) comprises:
taking, by the terminal device, the personal identification number as a passphrase to perform a second hash algorithm on data in the first vendor specific information element except the message integrity code of the first vendor specific information element, so as to generate the message integrity code for the verification.

16. The wireless access method of claim 11, wherein the third vendor specific information element comprises a message integrity code of the third vendor specific information element, and an authenticator nonce and an authenticator nonce hash value generated by the access point, wherein the step (c) comprises:
(c1) when the probe response is received, detecting, by the terminal device, whether the third vendor specific information element exists;
(c2) when the third vendor specific information element exists, performing, by the terminal device, an integrity verification of the third vendor specific information element by using the message integrity code of the third vendor specific information element and the personal identification code;
(c3) when the integrity verification is successful, performing, by the terminal device, a hash verification of the authenticator nonce by using the authenticator nonce hash value and the personal identification code; and
(c4) when the hash verification is successful, determining, by the terminal device, that the second access point authentication is successful.

17. The wireless access method of claim 16, wherein the step (c2) comprises:
taking, by the terminal device, the personal identification number as a passphrase to perform a third hash algorithm on data in the third vendor specific information element except the message integrity code of the third vendor specific information element, so as to generate the message integrity code for a verification;
comparing, by the terminal device, the message integrity code of the third vendor specific information element in the probe response and the message integrity code for the verification; and
when the message integrity code of the third vendor specific information element is the same as the message integrity code for the verification, determining, by the terminal device, that the integrity verification of the third vendor specific information element is successful.

18. The wireless access method of claim 16, wherein the step (c3) comprises:
(c31) generating, by the terminal device, an authenticator nonce hash value for verification according to the authenticator nonce and the personal identification number;
(c32) comparing, by the terminal device, the authenticator nonce hash value and the authenticator nonce hash value for verification; and
(c33) when the authenticator nonce hash value is the same as the authenticator nonce hash value for verification, determining, by the terminal device, that the hash verification is successful.

19. The wireless access method of claim 18, wherein the step (c31) comprises:
taking, by the terminal device, the personal identification number as a passphrase to perform a fourth hash algorithm on the authenticator nonce to generate the authenticator nonce hash value for the verification.

20. The wireless access method of claim 11, wherein the key encryption key is configured to perform a key encryption and decryption, the pairwise transient key is configured to perform a unicast encryption and decryption, the group transient key is configured to perform a broadcast encryption and decryption, the probe response further comprises a service set identifier of the access point and an authenticator address, and the step (d) comprises:
(d1) generating, by the terminal device, a pairwise master key according to the personal identification number and the service set identifier;
(d2) generating, by the terminal device, the pairwise transient key according to the pairwise master key, the authenticator address, the authenticator nonce, a supplicant address, and the supplicant nonce;
(d3) extracting, by the terminal device, a part of the pairwise transient key as the key encryption key; and
(d4) decrypting, by the terminal device, the encrypted pre-shared key and the encrypted group transient key by using the key encryption key.
